(19) United States
(12) Patent Application Publication
(10) Pub. No.: US 2026/0332488 A1
(43) Pub. Date: Oct. 22, 2026

(54) MANAGING A NETWORK USING MULTI-AGENT ADAPTIVE MACHINE LEARNING

(71) Applicant: Dell Products L.P., Round Rock, TX (US)

(72) Inventors: Jeebak Mitra, Ottawa (CA); Avinash Kumar, PATNA, BIHAR (IN)

(21) Appl. No.: 19/181,226

(22) Filed: Apr. 16, 2025

(51) Int. Cl. H04L 41/16; G06N 20/00; H04W 28/16

(52) U.S. Cl. CPC H04L 41/16; G06N 20/00; H04L 41/0803; H04L 41/0866; H04L 41/0894; H04W 28/16

(57) ABSTRACT

The technologies described herein are generally directed to managing a network using multi-agent, adaptive machine learning. For instance, a system can, based on a performance objective of a geographic area, a global policy model resulting in model training data. The example system may further include communicating the model training data to a base station of the base stations of the geographic area. The example system may further include, receiving from the base station, a model gradient value applicable to modifying the global policy model, with the model gradient value being identified based on an action implemented by the base station that was selected based on a base station maintained by the base station, that was trained based on the model training data and a local performance objective applicable to the base station.

### BACKGROUND

Modern approaches to scheduling resources in wireless networks may use different approaches to selecting the communication parameters of multiple base stations. Improving customer experiences by coordinating parameters among multiple base stations of a geographic area may be challenging, especially with diverse networks, complex performance goals, and rapidly changing network conditions.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. At least one memory may store computer executable instructions, and at least one processor may be configured to process the computer executable instructions that, when executed by the at least one processor, facilitate performance of operations. The operations may include receiving, from controller equipment of a geographic area that includes the base station equipment and other base station equipment other than the base station equipment, group training data identified by an inference of policy model trained based on wireless traffic of the geographic area and a group policy goal. The operations may further include, based on locally collected wireless traffic data, the group training data, and a local policy goal, training a local policy model, with the local policy model being employable to select a change to a wireless communication parameter applicable to communication by the base station equipment.

Additionally or alternatively, the local policy goal includes a first local policy goal, and the local policy model includes a first policy agent that was trained based on the first local policy goal and a second policy agent that was trained based on a second local policy goal. Additionally or alternatively, the local policy model may be used to select the change, the first policy agent being employable to select the change based on the first local policy goal being determined to have a higher assigned priority within a goal hierarchy than the second local policy goal.

Additionally or alternatively, the training of the local policy model may include, based on the local policy goal, selecting a subset of the training data that may be related to the local policy goal, with the local policy model being trained based on the subset of the training data. Additionally or alternatively, the local policy goal may include at least one of, a first local policy goal to maximize a total number of users served by the base station equipment, a second local policy goal to minimize an amount of power consumed by the base station equipment over a time period, or a third local policy goal to maximize a throughput provided by the base station equipment.

Additionally or alternatively, the group policy goal may include at least one of, a first group policy goal applicable to a group of base stations included in the geographic area, a second group policy goal applicable to a distribution of bandwidth among base stations of the geographic area, a third group policy goal applicable to a latency of communication by the base stations of the geographic area, a fourth group policy goal applicable to an estimated level of customer satisfaction of customers served by the base stations of the geographic area, a fifth group policy goal applicable to load balancing among the base stations of the geographic area, or a sixth group policy goal applicable to throughput applicable to the base stations of the geographic area.

Additionally or alternatively, the operations may further include employing the local policy model to select the change to the wireless communication parameter, and identifying a result of the change to the wireless communication parameter. Additionally or alternatively, the operations may further include, based on result information corresponding to the result, training the local policy model, and communicating training data to the controller equipment, with the training data being configured to train the policy model based on the training of the local policy model. Additionally or alternatively, the training data may include a model gradient applicable to the group policy model, with the model gradient being selected based on the result information. Additionally or alternatively, the operations may further include employing the local policy model to select the change to the wireless communication parameter, and based on the local policy goal and the group policy goal, selecting the change to the wireless communication parameter.

Additionally or alternatively, the wireless communication parameter may include at least one of, a number of customers to support by the base station equipment, a signal strength of the base station equipment, a beamforming direction of the base station equipment, a handover determination of the base station equipment, a signal conditioning applied by the base station equipment, a bandwidth allocation of the base station equipment, a congestion control policy of the base station equipment, or a remapping of a central unit of the base station equipment from a first distributed unit to a second distributed unit.

Additionally or alternatively, the local policy model may include a local policy model that estimates a present value of an action, and a future value of the action. Additionally or alternatively, the local policy model may include a deep q-learning model that was trained based on temporal difference learning. Additionally or alternatively, the operations may further include employing the local policy model to select the change to the wireless communication parameter, and based on a state of a geographic area of the base station equipment, sampling the local policy model to identify a first potential change to the wireless communication parameter and a second potential change to the wireless communication parameter, with the first potential change and the second potential change respectively including a first probability of advancing the local policy goal and a second probability of advancing the local policy goal. Additionally or alternatively, based on the first probability, selecting the first potential change to be the change to the wireless communication parameter. Additionally or alternatively, the selecting of the first potential change may be further based on the group policy goal weighted more than the local policy goal.

An example method may include, based on a performance objective of a geographic area, sampling a global policy model resulting in model training data, with the global policy model being trained based on wireless communication metrics received from respective base stations of the geographic area. The example method may further include, communicating to a base station of the base stations of the geographic area, the model training data. The example method may further include, receiving from the base station, a model gradient value applicable to modifying the global policy model, with the model gradient value being identified by the base station based on an action implemented by the base station, with the action being selected by the base station based on a base station policy model maintained by the base station, that was trained based on the model training data and a local performance objective applicable to the base station.

Additionally or alternatively, the model gradient value may include first model gradient value, and the method further includes organizing into a training batch, the first model gradient value and a second model gradient value received from another base station of the base stations of the geographic area other than the base station. Additionally or alternatively, based on a reception time, applying a first weight to the first model gradient value and a second weight to a second model gradient value, resulting in applied respective weights. Additionally or alternatively, based on the training batch and the applied respective weights, modifying the first model. Additionally or alternatively, the applying of the first weight to the first model gradient value may be based further on a data usefulness value of the base station representative of a usefulness of data provided by the base station as compared to the other base station.

An example non-transitory machine-readable medium may include executable instructions that, when executed by at least one processor, facilitate performance of operations. The operations may include, based on communication measurements identified by the wireless communication equipment, updating a model, with the model being employed by a multi-agent system that includes agent processes respectively corresponding to different performance objectives of the wireless communication equipment. The operations may further include employing the multi-agent system to identify potential modifications to operation of the wireless communication equipment in furtherance of respective performance objectives, with the potential modifications being constrained based on a policy objective that was received from policy controller equipment. The operations may further include, based on a hierarchy of the respective performance objectives, selecting a modification to the operation of the wireless communication equipment from the potential modifications.

Additionally or alternatively, the policy objective was employed by the policy controller equipment based on a deep learning neural network configured to evaluate a present value of an action and an estimated future value of the potential modifications. Additionally or alternatively, the operations may further include, based on a result of the modification, communicating training information to the policy controller equipment, with the training information being applicable to updating the deep learning neural network. Additionally or alternatively, the selecting of the modification based on the hierarchy may include, coordinating respective priorities of the respective performance objectives with the policy objective.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 is an architecture diagram of an example system that can facilitate managing a network using multi-agent, adaptive machine learning, in accordance with one or more embodiments;

FIG. 2 is an architecture diagram of an example system that can facilitate managing a network using multi-agent, adaptive machine learning, in accordance with one or more embodiments;

FIG. 3 includes a diagram that illustrates aspects of a part of an example system that can facilitate managing a network using multi-agent, adaptive machine learning, in accordance with one or more embodiments;

FIG. 4 includes a diagram that illustrates aspects of a part of an example system that can facilitate managing a network using multi-agent, adaptive machine learning, in accordance with one or more embodiments;

FIG. 5 includes a diagram that illustrates aspects of a part of an example system that can facilitate managing a network using multi-agent, adaptive machine learning, in accordance with one or more embodiments;

FIG. 6 depicts a flow diagram representing example operations of an example method that can facilitate managing a network using multi-agent, adaptive machine learning, in accordance with one or more embodiments;

FIG. 7 depicts an example system that can facilitate managing a network using multi-agent, adaptive machine learning, in accordance with one or more embodiments;

FIG. 8 depicts an example non-transitory machine-readable medium that can include executable instructions that, when executed by a processor of a system, can facilitate managing a network using multi-agent, adaptive machine learning, in accordance with one or more embodiments;

FIG. 9 is a schematic block diagram of a system with which the disclosed subject matter can interact; and

FIG. 10 illustrates an example block diagram of a computer operable to execute an embodiment of this disclosure.

### DETAILED DESCRIPTION

Various specific details of the disclosed embodiments are provided in the description below. One skilled in the relevant art(s) will recognize, however, that the techniques described herein can in some cases be practiced without one or more of the specific details, or with other methods, components, materials, etc. In other instances, well-known structures, materials, or operations are not shown or described in detail to avoid obscuring subject matter.

By utilizing one or more implementations as described herein, the performance, efficiency, and management of wireless network equipment can be improved, e.g., by providing approaches can incorporate goals for groups of wireless equipment (e.g., aggregated user satisfaction), with goals of individual wireless equipment, e.g., maintaining user connectivity, bandwidth, and other quality of service measures. One or more embodiments described herein are not abstract concepts; rather, they provide technical solutions to technical problems associated with the coordinated use of machine learning at a global and local level to improve the selection of communication parameters within the wireless network. Moreover, implementations described herein can provide these solutions in a manner that cannot reliably be performed by a human or even a plurality of humans, e.g., solutions provided are complex, require extensive and rapid parameter changes, and balance complex collections of global and local performance goals.

Aspects of the subject disclosure will now be described more fully hereinafter with reference to the accompanying drawings in which example components, graphs and operations are shown. In the following description, for purposes of explanation, numerous specific details are set forth in order to provide a thorough understanding of the various embodiments. However, the subject disclosure may be embodied in many different forms and should not be construed as limited to the examples set forth herein.

Generally speaking, one or more embodiments may improve a likelihood that wireless communication parameters implemented by base stations within a geographic area incorporate both immediate user satisfaction and long-term network performance, e.g., enabling the network to evolve intelligently under varying load conditions.

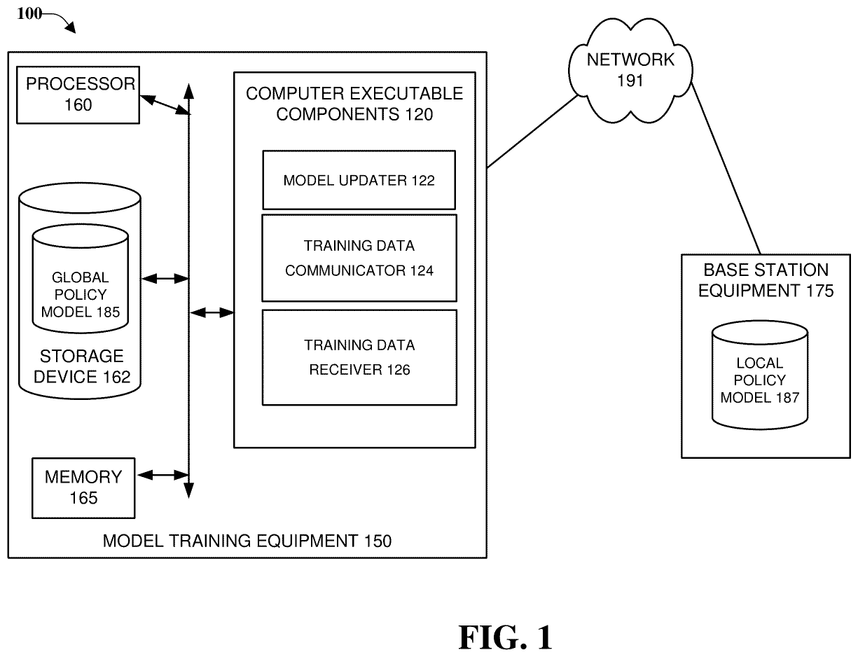

FIG. 1 is an architecture diagram of an example system 100 that can facilitate managing a network using multi-agent, adaptive machine learning, in accordance with one or more embodiments. For purposes of brevity, description of like elements and/or processes employed in other embodiments is omitted. As depicted, system 100 includes model training equipment 150 connected, via network 191, to base station equipment 175 that includes local policy model 187.

As used in this application, term like “user equipment (UE),” “mobile station,” “mobile,” subscriber station,” “subscriber equipment,” “access terminal,” “terminal,” “handset,” “mobile device,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “network device,” “base station,” “NodeB,” “evolved Node B (eNodeB),” “home Node B (HNB),” “home access point (HAP),” “cell device,” “cell,” and the like, are utilized interchangeably in the subject application, and refer to a wireless network component or appliance that can serve and receive data, control, voice, video, sound, gaming, or substantially any data-stream or signaling-stream to and from a set of subscriber stations or provider enabled devices. Data and signaling streams can include packetized or frame-based flows.

As depicted, model training equipment 150 can include memory 165 that can store one or more computer and/or machine readable, writable, and/or executable components 120 and/or instructions. In embodiments, model training equipment 150 can further include processor 160. In one or more embodiments, computer executable components 120, when executed by processor 160, can facilitate performance of operations defined by the executable component(s) and/or instruction(s). Computer executable components 120 can include model updater 122, training data communicator 124, training data receiver 126, and other components described or suggested by different embodiments described herein, that can improve the operation of system 100. Model training equipment 150 may further include storage device 162. In an example, storage device 162 may provide nonvolatile storage of data, data structures, computer executable instructions, and so forth, including group policy model 185.

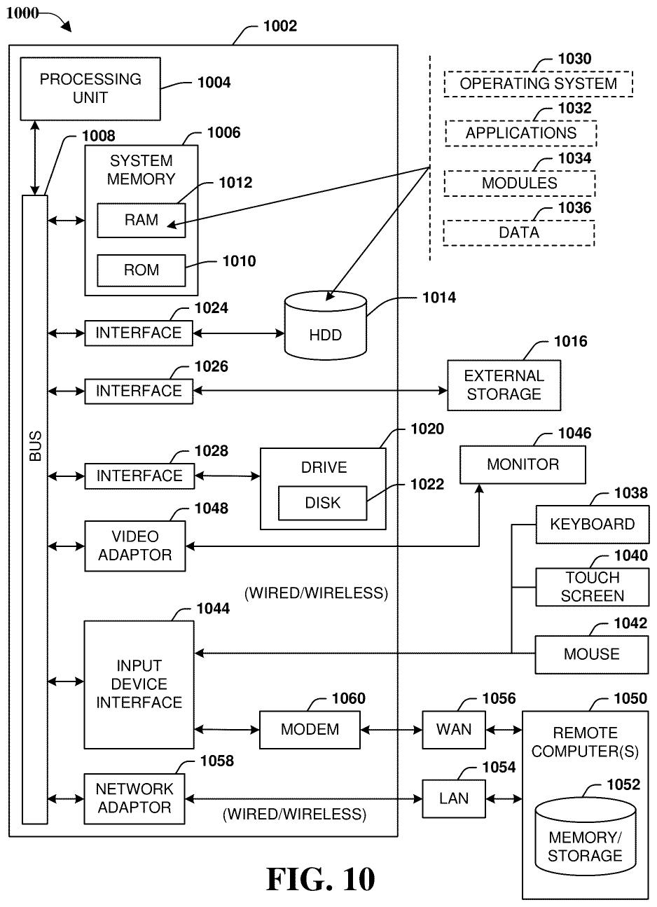

As discussed further with FIG. 10 below, network 191 can employ various wired and wireless networking technologies. For example, embodiments described herein can be exploited in substantially any wireless communication technology, comprising, but not limited to, global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), fifth generation core (5G Core), fifth generation option 3x (5G Option 3x), high speed packet access (HSPA), Z-Wave, Zigbee, wireless fidelity (Wi-Fi), and other 802.XX wireless technologies and/or legacy telecommunication technologies.

According to multiple embodiments, processor 160 can comprise one or more processors and/or electronic circuitry that can implement one or more computer and/or machine readable, writable, and/or executable components and/or instructions that can be stored on memory 165. For example, processor 160 can perform various operations that can be specified by such computer and/or machine readable, writable, and/or executable components and/or instructions including, but not limited to, logic, control, input/output (I/O), arithmetic, and/or the like. In some embodiments, processor 160 can comprise one or more components including, but not limited to, a central processing unit, a multi-core processor, a microprocessor, dual microprocessors, a microcontroller, a System on a Chip (SOC), an array processor, a vector processor, and other types of processors. Further examples of processor 160 are described below with reference to processing unit 1004 of FIG. 10. Such examples of processor 160 can be employed to implement any embodiments of the subject disclosure.

In some embodiments, memory 165 can comprise volatile memory (e.g., random access memory (RAM), static RAM (SRAM), dynamic RAM (DRAM), etc.) and/or non-volatile memory (e.g., read only memory (ROM), programmable ROM (PROM), electrically programmable ROM (EPROM), electrically erasable programmable ROM (EEPROM), etc.) that can employ one or more memory architectures. Further examples of memory 165 are described below with reference to system memory 1006 and FIG. 10. Such examples of memory 165 can be employed to implement any embodiments of the subject disclosure.

In one or more embodiments, computer executable components 120 can be used in connection with implementing one or more of the systems, devices, components, and/or computer-implemented operations shown and described in connection with FIG. 1 or other figures disclosed herein. In an example, memory 165 can store executable instructions that can facilitate operation of model updater 122, which in some implementations can, based on a performance objective of a geographic area, sample a global policy model resulting in model training data, with the global policy model being trained based on wireless communication metrics received from respective base stations of the geographic area. As used herein, the term “policy model,” and “model,” “machine learning model,” and the like, may be referenced to, and implemented as a “deep resource learning neural network.”

For example, in one or more embodiments, model updater 122 may, based on a performance objective of a geographic area that includes base station equipment 175, sample group policy model 185 resulting in model training data for distribution to base station equipment 175, with group policy model 185 being trained based on wireless communication metrics received from respective base stations of the geographic area, e.g., including base station equipment 175.

In example implementations described herein, geographic area performance objectives (also be termed group/global policy goals herein) may be termed group policy goals that are applicable to a geographic area that incorporates multiple base stations. Example group policy goals include, but are not limited to, specific identification of the geographic area, distribution of bandwidth among base stations of the geographic area, latency of communication by the base stations of the geographic area, an estimated level of customer satisfaction of customers served by the base stations of the geographic area, load balancing among the base stations of the geographic area, and throughput applicable to the base stations of the geographic area.

In another example, memory 165 can store executable instructions that can facilitate operation of training data communicator 124, which in some implementations may communicate to a base station of the base stations of the geographic area, the model training data. For example, in one or more embodiments, training data communicator 124 can communicate the model training data to base station equipment 175.

In another example, memory 165 can store executable instructions that can facilitate operation of training data receiver 126, which in some implementations may receive from the base station, a model gradient value applicable to modifying the global policy model, with the model gradient value being identified by the base station based on an action implemented by the base station, with the action being selected by the base station based on a base station policy model maintained by the base station, that was trained based on the model training data and a local performance objective applicable to the base station. For example, in one or more embodiments, training data receiver 126 may receive from base station equipment 175, a model gradient value applicable to modifying group policy model 185, with the model gradient value being identified by base station equipment 175 based on an action implemented by base station equipment 175, with the action being selected by base station equipment 175 based on local policy model 187 maintained by base station equipment 175, that was trained based on the model training data and a local performance objective applicable to base station equipment 175.

As used herein, the terms “group” and “global” applied to policies, goals, training data, and the like, may be used interchangeably to refer to more than one base station equipment in a geographic area. As used herein, the term “local” generally refers to goals and policies of a base station, or a group of base stations less than those referenced by the global goals and policies.

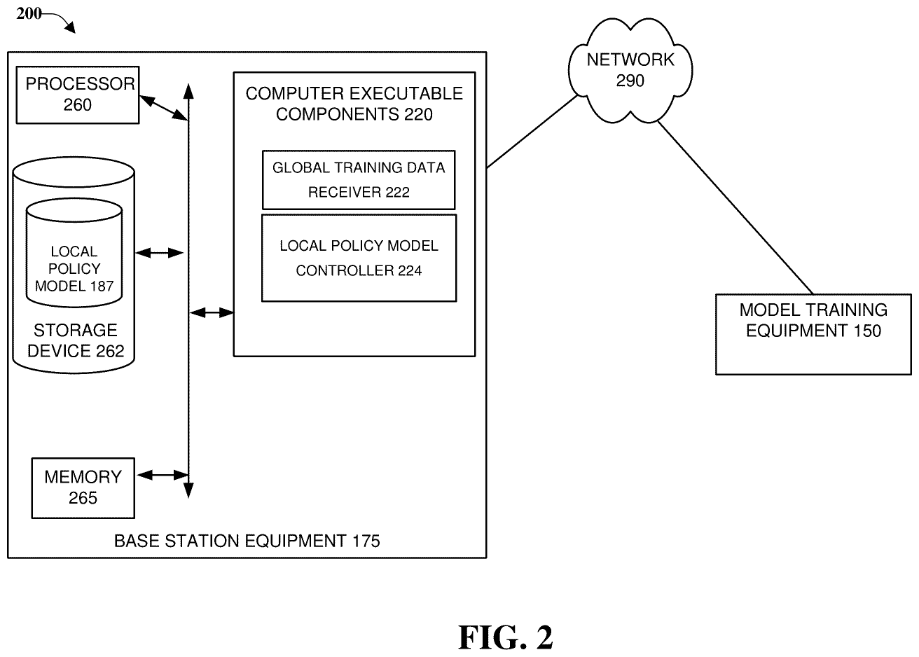

FIG. 2 is an architecture diagram of an example system 200 that can facilitate managing a network using multi-agent, adaptive machine learning, in accordance with one or more embodiments. For purposes of brevity, description of like elements and/or processes employed in other embodiments is omitted. As depicted, system 200 includes base station equipment 175 connected, via network 290, to model training equipment 150. Base station equipment 175 includes processor 260, memory 265, storage device 262, and computer executable components 220. It should be noted that the components of computer executable components 220 may be incorporated into computing equipment of base station equipment 175 and also be incorporated into external computing equipment shared by base station equipment 175.

In embodiments, processor 260 is similar to processor 160 and storage device 262 is similar to storage device 162, discussed above. According to multiple embodiments, memory 265 can store one or more computer and/or machine readable, writable, and/or executable components 220 and/or instructions. In one or more embodiments, computer executable components 220, when executed by processor 260, can facilitate performance of operations defined by the executable component(s) and/or instruction(s). Computer executable components 220 can include global training data receiver 222, local policy model controller 224, and other components described or suggested by different embodiments described herein, e.g., that can improve the operation of system 200, in accordance with one or more embodiments.

As discussed further with FIG. 10 below, network 290 can employ various wired and wireless networking technologies. For example, embodiments described herein can be exploited in substantially any wireless communication technology, comprising, but not limited to, global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), fifth generation core (5G Core), fifth generation option 3x (5G Option 3x), high speed packet access (HSPA), Z-Wave, Zigbee, wireless fidelity (Wi-Fi), and other 802.XX wireless technologies and/or legacy telecommunication technologies.

In an example implementation of base station equipment 175, memory 265 can store executable instructions that can facilitate operation of global training data receiver 222, which in some implementations, may receive, from controller equipment of a geographic area that includes the base station equipment and other base station equipment other than the base station equipment, training data identified by an inference of a policy model trained based on wireless traffic of the geographic area and a group policy goal. For example, in one or more embodiments, global training data receiver 222 may receive, from model training equipment 150, training data identified by an inference of group policy model 185 trained based on wireless traffic of the geographic area and a group policy goal.

In an example implementation of base station equipment 175, memory 265 can further store executable instructions that can facilitate operation of local policy model controller 224, which in some implementations, may, based on locally collected wireless traffic data, the training data, and a local policy goal, train a local policy model, with the local policy model being employable to select a change to a wireless communication parameter applicable to communication by the base station equipment. For example, in one or more embodiments, local policy model controller 224 may, based on wireless traffic data collected by base station 175, the training data received from model training equipment 150, and a local policy goal, train local policy model 187, with local policy model 187 being employable to select a change to a wireless communication parameter applicable to communication by base station equipment 175.

For the elements of FIGS. 1-2 discussed above, and the remaining FIGS. discussed below, the depiction and discussion of model training equipment 150, base station equipment 175, and all other equipment described herein, as being distributed among many separate computer systems should be considered non-limiting. In different embodiments, all of the functions described as performed by different equipment and the modules executed thereby, may be performed by a single system, virtual machine, any combination of hardware and software elements.

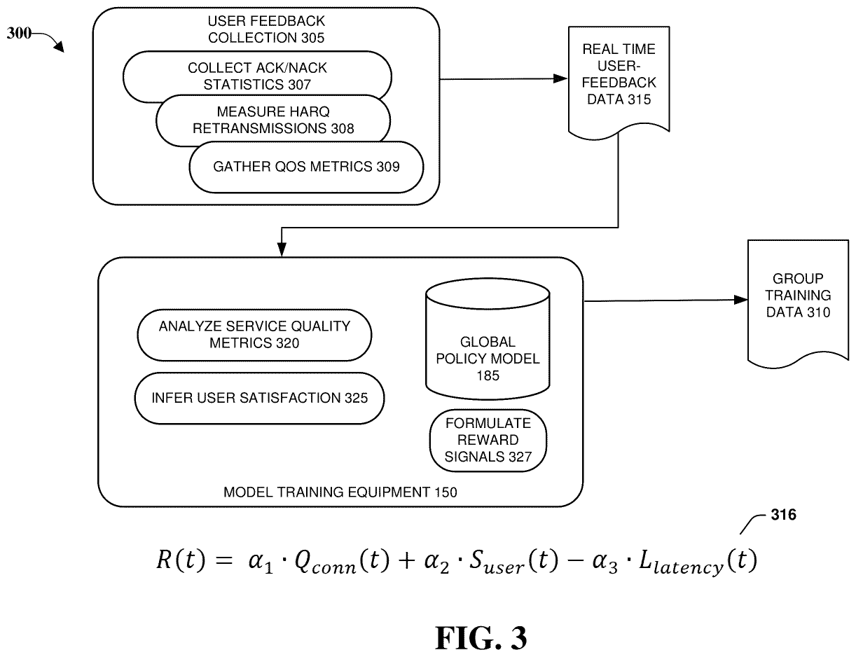

FIG. 3 includes a diagram that illustrates aspects of example system 300 that can facilitate managing a network using multi-agent, adaptive machine learning, in accordance with one or more embodiments. For purposes of brevity, description of like elements and/or processes employed in other embodiments is omitted. System 300 includes user feedback collection 305, real time user feedback 315, model training equipment 150, and group training data 310.

In one or more embodiments, user feedback collection 305 may be performed by a feedback integration interface that may link user behavior and network performance improvement. During user feedback collection 305, at 307 statistics describing acknowledgement signals (ACK)/negative acknowledgement signals (NACK) in the geographic area may be collected. At 308, hybrid automatic repeat request (HARQ) transmissions may be measured within the geographic area. At 309, quality of service (QoS) metrics within the geographic area may be gathered. In an implementation, while users do not provide explicit QoS feedback, the information gathered by user feedback collection 305 may be analyzed and used as proxies to infer service quality and user satisfaction. In an example implementation, user feedback collection 305 may use reward formulation 316 to quantify feedback, where Q_{conn}(t) represents the connection quality, Sᵤₛₑᵣ(t) is a measure of the user satisfaction and L_{latency}(t) is the average latency. The αᵢs with i=1,2,3 may be used to associate relative weights to the overall feedback metric R(t).

In embodiments, real-time user feedback 315 may be identified and communicated to model training equipment 150. After receiving real-time user feedback 315, at 320, model training equipment 150 may analyze the service quality metrics of real-time user feedback 315, and at 325, user satisfaction metrics may be inferred. In embodiments, group policy model 185 may be sampled and at 327, reward signals 327 may be formulated, and based thereon, group training data 310 may be identified.

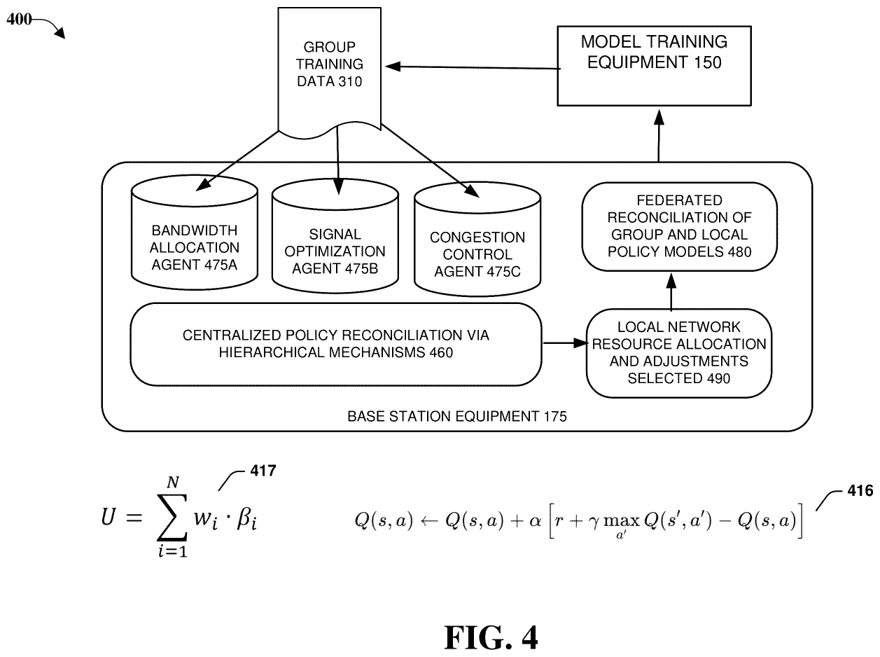

FIG. 4 includes a diagram that illustrates aspects of example system 400 that can facilitate managing a network using multi-agent, adaptive machine learning, in accordance with one or more embodiments. For purposes of brevity, description of like elements and/or processes employed in other embodiments is omitted. System 400 includes group training data 310 received from model training equipment 150, and base station equipment 175.

In embodiments, base station equipment 175 may classify functionalities of a wireless network through dedicated agents, includes policy agents 475A-C. For example, in an implementation, bandwidth allocation policy agent 475A may allocate bandwidth dynamically based on the density of user traffic, e.g., improving a likelihood of an equal distribution, while maintaining QoS requirements. In an implementation, signal optimization policy agent 475B may improve signal strength and coverage by fine-tuning antenna parameters, e.g., particularly for use by users in fringe areas or areas experiencing degraded connection quality. In an implementation, congestion control policy agent 475C may monitor traffic flow and reroute data packets to reduce the likelihood of congestion, e.g., potentially providing relatively low latency, even during peak hours.

In some embodiments, respective policy agents may have different optimization objectives and the respective policy agents may use a harmonization mechanism to arbitrate amongst the agents such that the network key performance indicator (KPI) with the highest priority plays a dominant role in the evolution of the network policy. In some embodiments, each network policy action may change the operational environment for other policy agents, e.g., facilitating the updating of policy agents develop online continuous learning. In some embodiments, network policy actions may be used to optimize different processes until an optimization metric no longer improves by more than a threshold step size in successive iterations.

This approach may improve coordination between decentralized agent actions and centralized goals, enabling adaptive, context-aware optimization of current (e.g., 5G) and future wireless network technologies (e.g., 6G and beyond) to meet user demands, reduce latency, and improve network efficiency under varying conditions. In some implementations, this coordination of multiple specialized policy agents (e.g., trained to address distinct network functionalities) may be termed a centralized training and decentralized execution approach, with policy agents to collaboratively using machine learning to develop improved performance strategies during a training phase, while autonomously executing decisions in real-world scenarios.

In an implementation, policy agents 475A-C may employ deep Q-learning with temporal differences to predict the long-term rewards of specific actions. For example, embodiments may use q-values that are developed using formula 416, where Q(s, a) is the action-value function, α is the learning rate, r is the immediate reward, γ is the discount factor, and s′, a′ are the next state and action. In implementations, by employing deep Q-learning with temporal difference learning, policy agents 475A-C may improve adaption to network dynamics, e.g., prioritizing immediate user satisfaction and long-term service quality.

At 460, the policies identified by policy agents 475A-C may be reconciled by centralized policy reconciliation using hierarchical mechanisms. In some embodiments, the multi-agent framework described herein may leverage hierarchical policy reconciliation to uniquely balance decentralized agent actions with centralized learning objectives. In some implementations, this mechanism may improve coordination across policy agents 475A-C, e.g., facilitating dynamic and context-aware tuning of 5G network services in real time. In some embodiments, the hierarchical policy reconciliation mechanism employed may improve user satisfaction and network performance by facilitating dynamic adaption by network services to changing conditions, e.g., conditions including, but not limited to, user mobility, traffic patterns, and service preferences.

An example performance goal for policy agents 475A-C may be modeled as global utility function 417, where U represents the global utility, wᵢ is the weight assigned to a user group or application class, and βi reflects the Quality of Service metric for the i^{th} group. The objective of the RL agents is to maximize U by balancing fairness and efficiency in resource allocation.

At 490, local network resource allocations and adjustments may be selected. In an implementation, the local network resource allocations and adjustments may be wireless communication parameters used by base station 175, including, but not limited to, a number of customers to support by the base station equipment, a signal strength of the base station equipment, a beamforming direction of the base station equipment, a handover determination of the base station equipment, a signal conditioning applied by the base station equipment, a bandwidth allocation of the base station equipment, a congestion control policy of the base station equipment, a remapping of a central unit of the base station equipment from a first distributed unit to a second distributed unit, and/or other similar parameters.

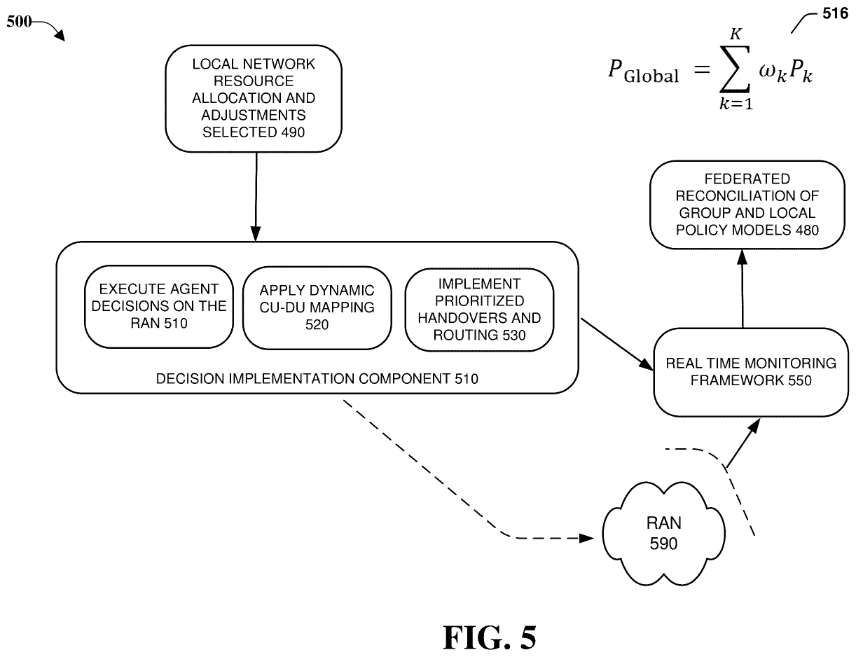

As discussed further with FIG. 5 below, at 480, the implemented network resource allocations and adjustments may be communicated for federated reconciliation of the group and local policy models.

FIG. 5 includes a diagram that illustrates aspects of example system 500 that can facilitate managing a network using multi-agent, adaptive machine learning, in accordance with one or more embodiments. For purposes of brevity, description of like elements and/or processes employed in other embodiments is omitted. System 500 includes the local network resource allocations and adjustments selected 490 for radio access network (RAN) 590, being received by decision implementation component 510.

At 510, decision implementation component 510 may execute agent decisions on RAN 590. In an embodiment, decision implementation component 510 (also termed a dynamic network management block, herein) may act as an operational backbone that integrates different functions described herein into a unified system. In embodiments, decision implementation component 510 may orchestrate the execution of learned policies across network layers, including centralized Units (CUs), distributed units (DUs), and user equipment (UE). For example, at 520, dynamic CU-DU mapping may be performed (e.g., for elements of base station equipment 175), and at 530, prioritized handovers and routing may be performed (e.g., for mobile devices served by base station equipment 175).

For example, at 550, the allocations and adjustments performed by decision implementation component 510 may be communicated to real-time monitoring framework 550, for monitoring and feedback results that may improve the likelihood that network adjustments are implemented as planned, e.g., real-time network states such as traffic fluctuations, mobility patterns, and service demands.

At 480, results of the real-time monitoring framework be used for the federated reconciliation of the group and local policy models. Some embodiments may use iterations of federated learning to allow agents to train locally using their respective data while sharing model gradients with model training equipment 150 to train group policy model 185. To facilitate maintaining system stability and convergence while combining centralized learning by wireless by model training equipment 150 with federated updates from policy agents 475A-C, one or more embodiments may employ a hierarchical policy reconciliation mechanism that may reduce conflicts by aligning local and global objectives.

For example, in formula 516, P_{Global} is the global policy and Pₖ is the local policy agent with K being the total number of local agents. In embodiments, formula 516 may model a global policy as a weighted sum of local policies Pₖ from K local agents, e.g., weighting factor k determines the influence of each local agent on the global policy, improving the likelihood that global network objectives include local agent priorities and vice-versa.

In some implementations, training data may be included in a training batch that applies a weighting to the changes to the model based on a reception time of the model updates, e.g., decreasing the weight of model updates as the underlying data ages. In another embodiments, training updates may be weighted based on the usefulness of past updates from the same source, e.g., comparing the data usefulness value of data provided by a base station to other base stations.

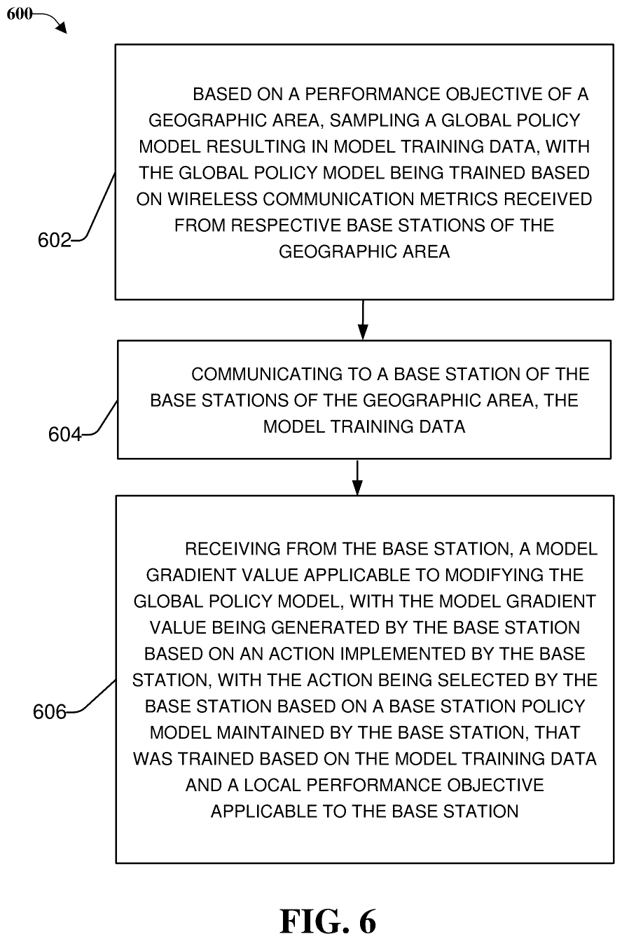

FIG. 6 depicts a flow diagram representing example operations of an example method 600 that can facilitate managing a network using multi-agent, adaptive machine learning, in accordance with one or more embodiments. For purposes of brevity, description of like elements and/or processes employed in other embodiments is omitted.

In some examples, one or more embodiments of method 600 can be implemented by model updater 122, training data communicator 124, training data receiver 126, and other components that can be used to implement aspects of method 600, in accordance with one or more embodiments. FIG. 6, described below illustrates methods in accordance with certain embodiments of this disclosure. While, for purposes of simplicity of explanation, the methods have been shown and described as series of acts, it is to be understood and appreciated that this disclosure is not limited by the order of acts, as some acts may occur in different orders and/or concurrently with other acts from that shown and described herein. For example, those skilled in the art will understand and appreciate that methods can alternatively be represented as a series of interrelated states or events, such as in a state diagram. Moreover, not all illustrated acts may be required to implement methods in accordance with certain embodiments of this disclosure.

At 602 of method 600, model updater 122 of model training equipment 150 can, based on a performance objective of a geographic area, sample a global policy model resulting in model training data, with the global policy model being trained based on wireless communication metrics received from respective base stations of the geographic area. At 604 of method 600, training data communicator 124 can communicate to a base station of the base stations of the geographic area, the model training data. At 606 of method 600, training data receiver 126 can receive from the base station, a model gradient value applicable to modifying the global policy model, with the model gradient value being identified by the base station based on an action implemented by the base station, with the action being selected by the base station based on a base station policy model maintained by the base station, that was trained based on the model training data and a local performance objective applicable to the base station.

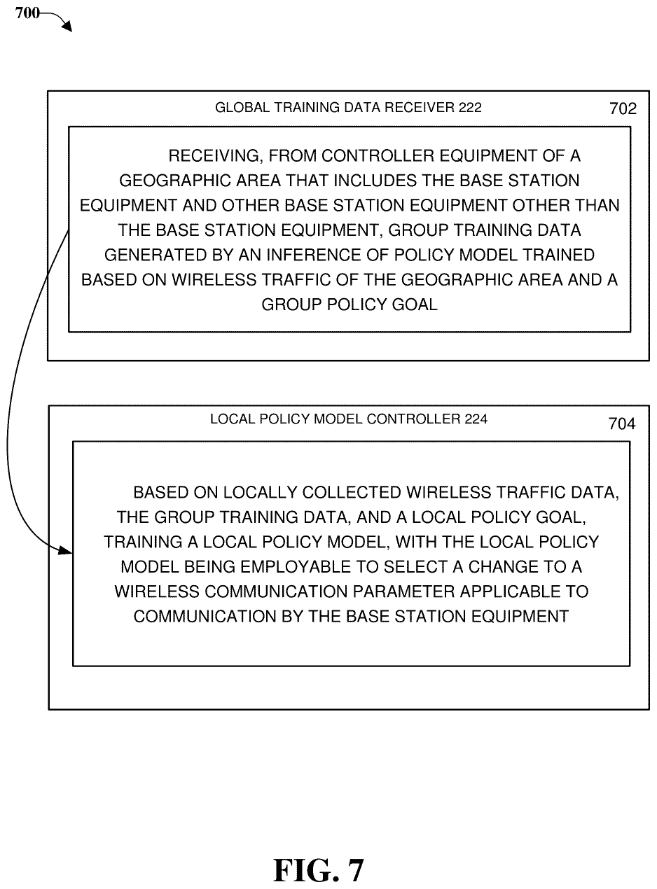

FIG. 7 depicts an example system 700 that can facilitate managing a network using multi-agent, adaptive machine learning, in accordance with one or more embodiments. For purposes of brevity, description of like elements and/or processes employed in other embodiments is omitted. System 700 includes at least one memory that stores computer executable components, and at least one processor that executes the computer executable components stored in the at least one memory, with the computer executable components including global training data receiver 222, local policy model controller 224, and other components that can be used to implement aspects of system 700, as described herein, in accordance with one or more embodiments.

At 702 of FIG. 7, global training data receiver 222 can receive, from controller equipment of a geographic area that includes the base station equipment and other base station equipment other than the base station equipment, global training data identified by an inference of a first global policy model trained based on wireless traffic of groups of multiple base station equipment. At 704 of FIG. 7, local policy model controller 224 can, based on locally collected wireless traffic data, the global training data, and a local policy goal, train a local policy model, with the local policy model being employable to select a change to a wireless communication parameter applicable to communication by the base station equipment.

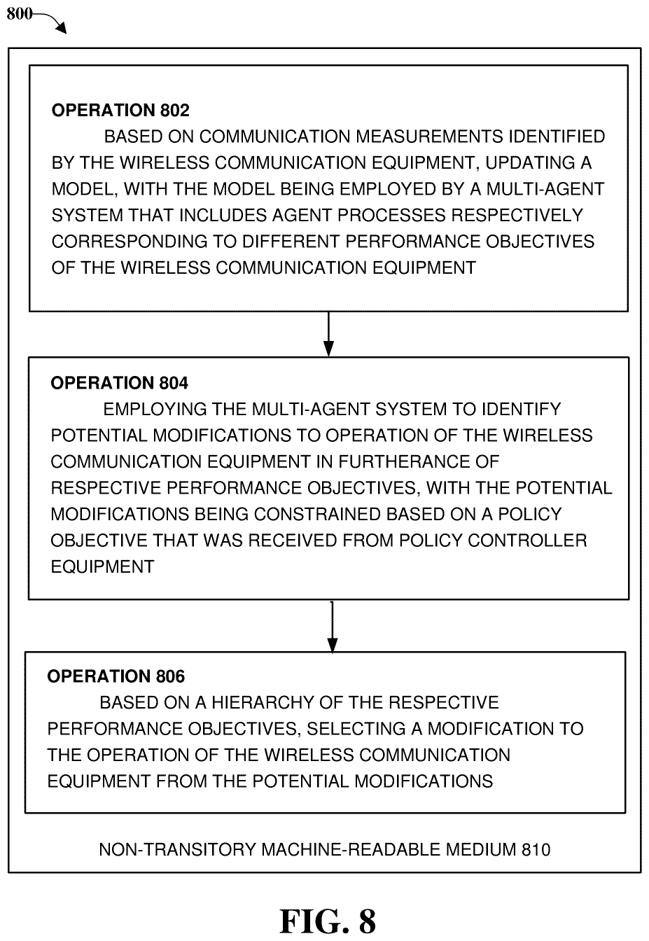

FIG. 8 depicts an example 800 non-transitory machine-readable medium 810 that can include executable instructions that, when executed by a processor of a system, can facilitate managing a network using multi-agent, adaptive machine learning, in accordance with one or more embodiments. For purposes of brevity, description of like elements and/or processes employed in other embodiments is omitted.

As depicted, non-transitory machine-readable medium 810 includes executable instructions that, when executed by at least one processor of a machine learning device, facilitate performance of operations that include operation 802 which can, based on communication measurements identified by the wireless communication equipment, update a model, with the model being employed by a multi-agent system that includes agent processes respectively corresponding to different performance objectives of the wireless communication equipment.

The operations may further include operation 804 which can employ the multi-agent system to identify potential modifications to operation of the wireless communication equipment in furtherance of respective performance objectives, with the potential modifications being constrained based on a policy objective that was received from policy controller equipment. The operations may further include operation 806 which can, based on a hierarchy of the respective performance objectives, select a modification to the operation of the wireless communication equipment from the potential modifications.

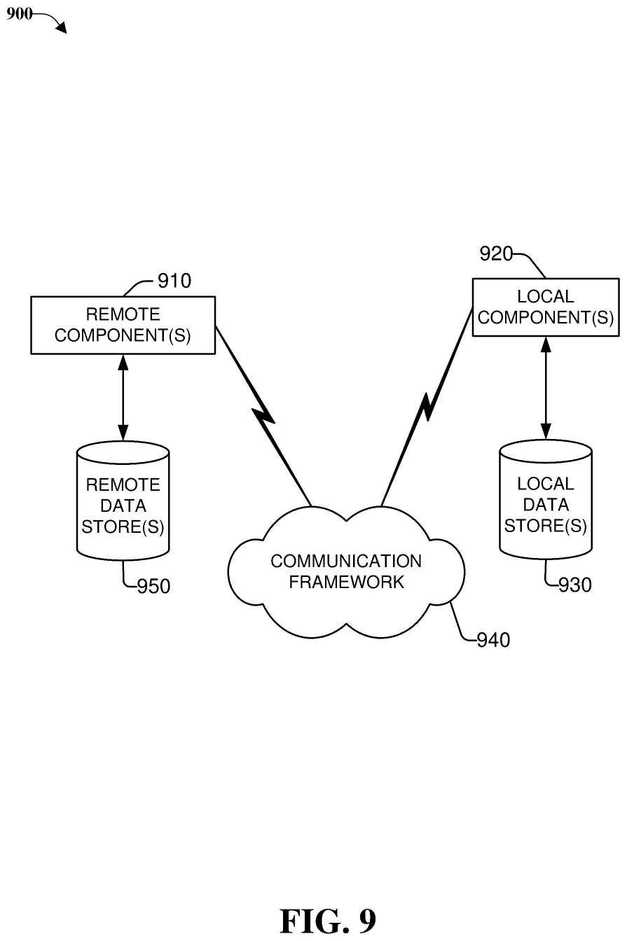

FIG. 9 is a schematic block diagram of a system 900 with which the disclosed subject matter can interact. The system 900 comprises one or more remote component(s) 910. The remote component(s) 910 can be hardware and/or software (e.g., threads, processes, computing devices). In some embodiments, remote component(s) 910 can be a distributed computer system, connected to a local automatic scaling component and/or programs that use the resources of a distributed computer system, via communication framework 940. Communication framework 940 can comprise wired network devices, wireless network devices, mobile devices, wearable devices, RAN devices, gateway devices, femtocell devices, servers, etc. The system 900 also comprises one or more local component(s) 920. The local component(s) 920 can be hardware and/or software (e.g., threads, processes, computing devices).

One possible communication between a remote component(s) 910 and a local component(s) 920 can be in the form of a data packet adapted to be transmitted between two or more computer processes. Another possible communication between a remote component(s) 910 and a local component(s) 920 can be in the form of circuit-switched data adapted to be transmitted between two or more computer processes in radio time slots. The system 900 comprises a communication framework 940 that can be employed to facilitate communications between the remote component(s) 910 and the local component(s) 920, and can comprise an air interface, e.g., Uu interface of a UMTS network, via a long-term evolution (LTE) network, etc. Remote component(s) 910 can be operably connected to one or more remote data store(s) 950, such as a hard drive, solid state drive, SIM card, device memory, etc., that can be employed to store information on the remote component(s) 910 side of communication framework 940. Similarly, local component(s) 920 can be operably connected to one or more local data store(s) 930, that can be employed to store information on the local component(s) 920 side of communication framework 940.

In order to provide a context for the various aspects of the disclosed subject matter, the following discussion is intended to provide a brief, general description of a suitable environment in which the various aspects of the disclosed subject matter can be implemented. While the subject matter has been described above in the general context of computer executable instructions of a computer program that runs on a computer and/or computers, those skilled in the art will recognize that the disclosed subject matter also can be implemented in combination with other program modules. Generally, program modules comprise routines, programs, components, data structures, etc. that performs particular tasks and/or implement particular abstract data types.

In the subject specification, terms such as “store,” “storage,” “data store,” “data storage,” “database,” and substantially any other information storage component relevant to operation and functionality of a component, refer to “memory components,” or entities embodied in a “memory” or components comprising the memory. It is noted that the memory components described herein can be either volatile memory or non-volatile memory, or can comprise both volatile and non-volatile memory, for example, by way of illustration, and not limitation, volatile memory 1020 (see below), non-volatile memory 1022 (see below), disk storage 1024 (see below), and memory storage, e.g., local data store(s) 930 and remote data store(s) 950, see below. Further, nonvolatile memory can be included in read only memory, programmable read only memory, electrically programmable read only memory, electrically erasable read only memory, or flash memory. Volatile memory can comprise random access memory, which acts as external cache memory. By way of illustration and not limitation, random access memory is available in many forms such as synchronous random-access memory, dynamic random access memory, synchronous dynamic random access memory, double data rate synchronous dynamic random access memory, enhanced synchronous dynamic random access memory, SynchLink dynamic random access memory, and direct Rambus random access memory. Additionally, the disclosed memory components of systems or methods herein are intended to comprise, without being limited to comprising, these and any other suitable types of memory.

Moreover, it is noted that the disclosed subject matter can be practiced with other computer system configurations, comprising single-processor or multiprocessor computer systems, mini-computing devices, mainframe computers, as well as personal computers, hand-held computing devices (e.g., personal digital assistant, phone, watch, tablet computers, netbook computers), microprocessor-based or programmable consumer or industrial electronics, and the like. The illustrated aspects can also be practiced in distributed computing environments where tasks are performed by remote processing devices that are linked through a communications network; however, some, if not all, aspects of the subject disclosure can be practiced on stand-alone computers. In a distributed computing environment, program modules can be located in different systems, e.g., both local and remote memory storage devices.

Referring now to FIG. 10, in order to provide additional context for various embodiments described herein, FIG. 10 and the following discussion are intended to provide a brief, general description of a suitable computing environment 1000 in which the various embodiments described herein can be implemented.

While the embodiments have been described above in the general context of computer executable instructions that can run on one or more computers, those skilled in the art will recognize that the embodiments can also be implemented in combination with other program modules and/or as a combination of hardware and software. For purposes of brevity, description of like elements and/or processes employed in other embodiments is omitted.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid-state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can also be connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless base station (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations,” this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application program interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

Additionally, the terms “core-network,” “core,” “core carrier network,” “carrier-side,” or similar terms can refer to components of a telecommunications network that typically provides some or all of aggregation, authentication, call control and switching, charging, service invocation, or gateways. Aggregation can refer to the highest level of aggregation in a service provider network wherein the next level in the hierarchy under the core nodes is the distribution networks and then the edge networks. User equipment does not normally connect directly to the core networks of a large service provider but can be routed to the core by way of a switch or radio area network. Authentication can refer to determinations regarding whether the user requesting a service from the telecom network is authorized to do so within this network or not. Call control and switching can refer determinations related to the future course of a call stream across carrier equipment based on the call signal processing. Charging can be related to the collation and processing of charging data identified by various network nodes. Two common types of charging mechanisms found in present day networks can be prepaid charging and postpaid charging. Service invocation can occur based on some explicit action (e.g., call transfer) or implicitly (e.g., call waiting). It is to be noted that service “execution” may or may not be a core network functionality as third-party network/nodes may take part in actual service execution. A gateway can be present in the core network to access other networks. Gateway functionality can be dependent on the type of the interface with another network.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks include Geocast technology; broadcast technologies (e.g., sub-Hz, ELF, VLF, LF, MF, HF, VHF, UHF, SHF, THz broadcasts, etc.); Ethernet; X.25; powerline-type networking (e.g., PowerLine AV Ethernet, etc.); femto-cell technology; Wi-Fi; Worldwide Interoperability for Microwave Access (WiMAX); Enhanced General Packet Radio Service (Enhanced GPRS); Third Generation Partnership Project (3GPP or 3G) Long Term Evolution (LTE); 3GPP Universal Mobile Telecommunications System (UMTS) or 3GPP UMTS; Third Generation Partnership Project 2 (3GPP2) Ultra Mobile Broadband (UMB); High Speed Packet Access (HSPA); High Speed Downlink Packet Access (HSDPA); High Speed Uplink Packet Access (HSUPA); GSM Enhanced Data Rates for GSM Evolution (EDGE) RAN or GERAN; UMTS Terrestrial Radio Access Network (UTRAN); or LTE Advanced.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any embodiment or design described herein as “exemplary” and/or “demonstrative” is not necessarily to be construed as preferred or advantageous over other embodiments or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. Base station equipment, comprising:
at least one memory that stores computing executable instructions; and
at least one processor configured to process the computing executable instructions that, when executed by the at least one processor, facilitate performance of operations, comprising:
receiving, from controller equipment employable to manage a geographic area comprising the base station equipment and other base station equipment other than the base station equipment, group training data identified by an inference of a group policy model trained based on wireless traffic of the geographic area and a group policy goal, and
based on locally collected wireless traffic data, the group training data, and a local policy goal, training a local policy model, wherein the local policy model is employable to select a change to a wireless communication parameter applicable to communication by the base station equipment.

2. The base station equipment of claim 1, wherein the local policy goal comprises a first local policy goal, and wherein the local policy model comprises a first policy agent that was trained based on the first local policy goal and a second policy agent that was trained based on a second local policy goal.

3. The base station equipment of claim 2, wherein the local policy model is employable to select the change, the first policy agent being employable to select the change based on the first local policy goal being determined to have a higher assigned priority within a goal hierarchy than the second local policy goal.

4. The base station equipment of claim 1, wherein the training of the local policy model comprises:
based on the local policy goal, selecting a subset of the group training data that is related to the local policy goal; and
training the local policy model based on the subset of the group training data.

5. The base station equipment of claim 1, wherein the local policy goal comprises at least one of:
a first local policy goal to maximize a total number of users served by the base station equipment,
a second local policy goal to minimize an amount of power consumed by the base station equipment over a time period, or
a third local policy goal to maximize a throughput provided by the base station equipment.

6. The base station equipment of claim 1, wherein the group policy goal comprises at least one of:
a first group policy goal applicable to base stations comprised in the geographic area,
a second group policy goal applicable to a distribution of bandwidth among base stations of the geographic area,
a third group policy goal applicable to a latency of communication by the base stations of the geographic area,
a fourth group policy goal applicable to an estimated level of customer satisfaction of customers served by the base stations of the geographic area,
a fifth group policy goal applicable to load balancing among the base stations of the geographic area, or
a sixth group policy goal applicable to throughput applicable to the base stations of the geographic area.

7. The base station equipment of claim 1, wherein the operations further comprise:
employing the local policy model to select the change to the wireless communication parameter;
identifying a result of the change to the wireless communication parameter; and
based on result information corresponding to the result:
training the local policy model, and
communicating training data to the controller equipment, wherein the training data was configured to train the group policy model based on the training of the local policy model.

8. The base station equipment of claim 7, wherein the training data comprises:
a model gradient applicable to the group policy model, and wherein the model gradient was selected based on the result information.

9. The base station equipment of claim 1, wherein the operations further comprise:
employing the local policy model to select the change to the wireless communication parameter, and
based on the local policy goal and the group policy goal, selecting the change to the wireless communication parameter.

10. The base station equipment of claim 1, wherein the wireless communication parameter comprises at least one of:
a number of customers to be supported by the base station equipment,
a signal strength of the base station equipment,
a beamforming direction of the base station equipment,
a handover determination of the base station equipment,
a signal conditioning applied by the base station equipment,
a bandwidth allocation of the base station equipment,
a congestion control policy of the base station equipment, or
a remapping of a central unit of the base station equipment from a first distributed unit to a second distributed unit.

11. The base station equipment of claim 1, wherein the local policy model comprises a local policy model that estimates:
a present value of an action, and
a future value of the action.

12. The base station equipment of claim 11, wherein the local policy model comprises a deep q-learning model that was trained based on temporal difference learning.

13. The base station equipment of claim 1, wherein the operations further comprise:
employing the local policy model to select the change to the wireless communication parameter, comprising:
based on a state of a geographic area of the base station equipment, sampling the local policy model to identify a first potential change to the wireless communication parameter and a second potential change to the wireless communication parameter, wherein the first potential change and the second potential change respectively comprise a first probability of advancing the local policy goal and a second probability of advancing the local policy goal; and
based on the first probability, selecting the first potential change to be the change to the wireless communication parameter.

14. The base station equipment of claim 13, wherein the selecting of the first potential change is further based on the group policy goal weighted more than the local policy goal.

15. A method, comprising:
based on a performance objective of a geographic area, sampling, by a computing system comprising at least one processor, a global policy model resulting in model training data, wherein the global policy model was trained based on wireless communication metrics received from respective base stations of the geographic area;
communicating, by the computing system, to a base station of the base stations of the geographic area, the model training data; and
receiving, by the computing system, from the base station, a model gradient value applicable to modifying the global policy model, wherein the model gradient value was identified by the base station based on an action implemented by the base station, and wherein the action was selected by the base station based on a base station policy model maintained by the base station, that was trained based on the model training data and a local performance objective applicable to the base station.

16. The method of claim 15, wherein the model gradient value comprises first model gradient value, and wherein the method further comprises:
organizing, by the computing system, into a training batch, the first model gradient value and a second model gradient value received from another base station of the base stations of the geographic area other than the base station;
based on a reception time, applying, by the computing system, a first weighting to the to the first model gradient value and a second weighting to the second model gradient value, resulting in applied respective weights; and
based on the training batch and the applied respective weights, modifying, by the computing system, the first model.

17. The method of claim 16, wherein the applying of the first weighting to the first model gradient value is based further on a data usefulness value of the base station representative of a usefulness of data provided by the base station as compared to the other base station.

18. A non-transitory machine-readable medium comprising executable instructions that, when executed by at least one processor of wireless communication equipment, facilitate performance of operations, the operations comprising:
based on communication measurements identified by the wireless communication equipment, updating a model, wherein the model is employed by a multi-agent system comprising agent processes respectively corresponding to different performance objectives of the wireless communication equipment;
employing the multi-agent system to identify potential modifications to operation of the wireless communication equipment in furtherance of respective performance objectives, wherein the potential modifications are constrained based on a policy objective that was received from policy controller equipment; and
based on a hierarchy of the respective performance objectives, selecting a modification to the operation of the wireless communication equipment from the potential modifications.

19. The non-transitory machine-readable medium of claim 18, wherein the policy objective was employed by the policy controller equipment based on a deep learning neural network configured to evaluate a present value of an action and an estimated future value of the potential modifications, and wherein the operations further comprise:
based on a result of the modification, communicating training information to the policy controller equipment, wherein the training information is applicable to updating the deep learning neural network.

20. The non-transitory machine-readable medium of claim 18, wherein the selecting of the modification based on the hierarchy comprises:
coordinating respective priorities of the respective performance objectives with the policy objective.
